(19) United States
(12) Patent Application Publication
(10) Pub. No.: US 2005/0016308 A1
(43) Pub. Date: Jan. 27, 2005

(54) Tube guide for ball screw, ball screw and method for manufacturing thereof

(75) Inventor: Eiji Hayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/663,807

(22) Filed: Sep. 17, 2003

(30) Foreign Application Priority Data
Sep. 17, 2002 (JP) P.2002-270282

(51) Int. Cl. F16H 25/22

(52) U.S. Cl. 74/424.86

(57) ABSTRACT

A tube guide for a ball screw having a screw shaft including a ball rolling groove; a nut including a ball rolling groove; a plurality of balls disposed in a ball rolling passage; and, a ball circulation tube and including a ball scooping portion in an end portion thereof, wherein the tube guide is used for mounting the ball circulation tube onto the nut, has an outer shape matched to the inner shape of a tube guide insertion hole formed in the nut so as to correspond to the insertion position of the ball scooping portion, and includes a scooping portion insertion hole consisting of a penetration hole formed so as to have an inner shape matched to the outer shape of the ball scooping portion, and wherein the tube guide is interposed between the ball scooping portion and the tube guide insertion hole.

### BACKGROUND OF THE INVENTION

1. Field of the Invention

The present invention relates to a tube guide for a ball screw, a ball screw and a method for manufacturing a ball screw and, in particular, to a mounting structure for mounting a ball circulation tube in a ball screw of an external circulation type.

2. Description of the Related Art

In the case of a ball screw, as a ball circulating type, there is known an external circulation type.

According to this external circulation type, there is used a structure in which a ball circulation tube is disposed on the outer surface of a nut threadedly engaged with a screw shaft through a large number of balls so as to be exposed, and the balls are guided externally of the nut and are circulated.

By the way, in the case of the conventional ball screw of an external circulation type, there is found a problem that the balls collide with ball scooping portions respectively disposed in the two end portions of the ball circulation tube to thereby damage the ball scooping portions as well as cause vibrations and noises.

Therefore, in order to solve this problem, there is proposed a technology which is disclosed in the following JP-UM-A-59-39352.

According to the technology disclosed in the JP-UM-A-59-39352, as shown in FIGS. 10 and 11, firstly, a nut 200 is machined to form therein a tube insertion hole 900 so as to be inclined at the lead angle θ of the ball screw, through which tube insertion hole 900 a ball circulation tube 400 can be inserted into the nut 200. Also, the ball circulation tube 400 is divided into two portions while the two ball scooping portions 400a thereof are also inclined at the lead angle θ. Next, the thus divided ball circulation tubes 400 are respectively inserted into their associated tube insertion holes 900. Finally, two mounting screws 15 are fastened to their associated screw holes 16 through a tube holder 14, thereby fixing the ball circulation tubes 400 to an installation surface 8 formed in the outer surface of the nut 200.

However, in the technology disclosed in the JP-UM-A-59-39352, since the tube insertion hole 900 is formed in the nut 200 so as to be inclined at the lead angle θ of the ball screw, the operation to machine and form the tube insertion hole 900 is difficult. And, especially, as shown in FIG. 9, in the vicinity of the flange portion 20 of the nut 200, a machining tool 120 can interfere with the flange portion 20 and thus, sometimes, it is impossible to machine the tube insertion hole 900. Also, since the ball circulation tube 400 is divided into two portions, when assembling the two-divided ball circulation tubes 400 to the nut 200, they must be assembled with such sufficient care that can prevent generation of a step portion between the connecting portions 400b of the tubes 400.

Thus, in order to solve this problem, there is proposed a technology which is disclosed in the following JP-UM-A-63-132156.

According to the technology disclosed in the patent literature, as shown in FIGS. 7 and 8, firstly, a nut 201 is machined to form an odd-looking tube insertion hole 901 the width of which is greater than the diameter of a ball circulation tube 4 and also which, on the bottom portion side thereof, includes an assembling reference surface 901a for assembly of the ball circulation tube 4 to the nut 201. Also, the ball circulation tube 4 is not divided but is formed as an integral body in such a manner that two ball scooping portions 4a formed in the two end portions of the ball circulation tube 4 are respectively inclined at the lead angle θ of the ball screw. Next, the ball circulation tube 4 is inserted into a tube insertion hole 901. Finally, similarly to the technology disclosed in the patent literature, the ball circulation tube 4 is fixed to the installation surface 8.

However, in the case of the technology disclosed in the JP-UM-A-63-132156, since the tube insertion hole 901 includes the inclined assembling reference surface 901a in the inner surface thereof, that is, since it requires step machining, it is still troublesome to machine the tube insertion hole 901. Also, after assembly of the ball circulation tube 4, there is generated a clearance 901b between the ball circulation tube 4 and tube insertion hole 901. This raises the following problems: that is, a foreign substance can invade the interior of the nut 201; and, the noises of the interior of the nut 201 can leak to the outside to thereby increase the noises of the ball screw.

### SUMMARY OF THE INVENTION

The present invention aims at eliminating the drawbacks found in the above-mentioned conventional screw ball structures. Accordingly, it is an object of the invention to provide a tube guide for a ball screw, a ball screw and a method for manufacturing a ball screw which not only can enhance the machining efficiency of the tube insertion hole for insertion of the ball circulation tube and the assembling efficiency of the ball circulation tube but also can prevent the ball scooping portions of the ball circulation tube against damage and can reduce vibrations and noises.

In attaining the above object, according to the invention as set forth in a first aspect, there is provided a tube guide for a ball screw having a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, wherein the tube guide is used for mounting the ball circulation tube onto the nut, has an outer shape matched to the inner shape of a tube guide insertion hole formed in the nut so as to correspond to the insertion position of the ball scooping portion, and includes a scooping portion insertion hole consisting of a penetration hole formed so as to have an inner shape matched to the outer shape of the ball scooping portion, and wherein the tube guide is interposed between the ball scooping portion and the tube guide insertion hole.

Also, according to the invention as set forth in a second aspect, a tube guide for a ball screw as set forth in the first aspect, wherein the inner shape of the tube guide insertion hole is formed a cylindrical shape.

Here, the term “cylindrical shape” is a shape which can be obtained when a machining tool is rotated around the axial line thereof. For example, in case where feed cutting is not executed, there is obtained a cylindrical shape. And, in case where such feed cutting is executed, cylindrical shapes are machined successively to thereby provide an elliptically cylindrical shape. According to the invention, the term “cylindrical shape” is used to contain both of them.

Also, according to the invention as set forth in a third aspect, a tube guide for a ball screw as set forth in the second aspect, wherein the axial line of the cylindrical shape is set perpendicular to the axial line of the nut.

And, according to the invention as set forth in a fourth aspect, a tube guide for a ball screw as set forth in any one of the first to third aspects, wherein the scooping portion insertion hole has a ball circulation passage scooping angle set so as to correspond to the lead angle of the ball screw.

Further, according to the invention as set forth in a fifth aspect, a tube guide for a ball screw as set forth in any one of the first to fourth aspects, wherein the tube guide is made of elastic material.

In a tube guide for a ball screw according to the invention, when mounting the ball circulation tube onto the nut, the ball circulation tube is not directly inserted into the tube insertion hole but the two end portions of the ball circulation tube are fitted through two tube guides of this type into their associated tube guide insertion holes formed in the nut.

Therefore, the ball scooping portion and tube guide insertion hole can be made independent of each other and thus they can be respectively designed properly. That is, such a device for the ball scooping portion as necessary to form the ball circulation passage in a desirable manner can be set in a wide range free from restraint with respect to the machining operation of the nut. Also, similarly, the machining operation of the nut can be executed free from restraint with respect to the ball scooping portion, which can increase the degree of freedom of the nut machining method and the degree of freedom of the nut shape; and, therefore, the tube guide insertion hole can be formed in the nut using the method that is most inexpensive and high in productivity.

And, in case where the tube guide interposed between the ball scooping portion and tube guide insertion hole is mounted so as to be matched to both of them, the tube guide can be assembled without causing any clearance.

Therefore, it is possible to provide a ball screw which not only can prevent the ball scooping portion against damage and can prevent a foreign substance from entering the interior of the nut from outside, but also can reduce vibrations and noises.

Also, in case where the shape, material and manufacturing method of the tube guide interposed between the ball scooping portion and tube guide insertion hole are devised variously, the function and performance of the tube guide can be enhanced further.

That is, according to the invention as set forth in Second aspect, since the inner shape of the tube guide insertion hole is formed as a cylindrical shape, the tube guide insertion hole can be machined using an ordinary machining tool.

Also, according to the invention as set forth in Third aspect, because the axial line of the above-mentioned cylindrical shape is set perpendicular to the axial line of the nut, there can be eliminated the need for use of a complicated machining jig.

Also, according to the invention as set forth in Fourth aspect, since the scooping portion insertion hole has the ball circulation passage scooping angle that is set so as to correspond to the lead angle of the ball screw, it is possible to construct a ball circulation passage which is composed of a smooth passage. This structure can prevent the ball scooping portion against damage properly.

Further, according to the invention as set forth in Fifth aspect, because the tube guide is made of elastic material, even when the ball collides with the ball scooping portion, the collision load can be absorbed by the elastic action of the tube guide; and, therefore, the ability of the ball screw to reduce vibrations and noises can be enhanced further.

And, according to the invention as set forth in a sixth aspect, there is provided a ball screw having: a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, wherein the nut includes a tube guide insertion hole corresponded to the insertion position of the ball scooping portion, and the ball circulation tube is mounted on the nut through a tube guide as set forth in any one of the first to fifth aspects between the ball scooping portion and the tube guide insertion hole.

Therefore, according to the invention as set forth in Sixth aspect, since there can be obtained the action of a tube guide as set forth in any one of the first to fifth aspects, there can be provided a ball screw which can provide the effects that correspond to the previously described aspects: that is, it can enhance the machining efficiency of the tube guide insertion hole and the assembling efficiency of the ball circulation tube, can prevent the damage of the ball scooping portion and the entrance of a foreign substance into the interior of the nut from outside, and can reduce vibrations and noises.

Also, according to the invention as set forth in a seventh aspect, there is provided a method for manufacturing a ball screw having: a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of: forming a tube guide insertion hole on the nut at a position corresponding to the insertion position of the ball scooping portion; mounting the tube guide as set forth in any one of the first to fifth aspects on the two end portions of the ball circulation tube; inserting the two end portions of the ball circulation tube with the tube guide into the tube guide insertion holes; and, fixing the ball circulation tube to the nut.

According to the invention as set forth in Seventh aspect, the ball screw is manufactured in such a manner that the step of mounting the ball circulation tube is divided into two steps by using the tube guide. Thanks to this, the following contradicting problems can be solved: that is, one is an assembling inconvenience which is produced as an aftereffect when satisfying the function and performance required of the ball circulation tube, and the other is an inconvenience which is produced when satisfying the assembling need and has an ill effect on the function and performance. In other words, the required function and performance of the ball circulation tube and the assembling need can be both satisfied. Therefore, there can be provided a ball screw which can further enhance the productivity and assembling efficiency of the ball screw as well as can reduce the vibrations and noises thereof.

Also, according to the invention as set forth in a eighth aspect, a method for manufacturing a ball screw as set forth in the seventh aspect, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

That is, according to the invention as set forth in the eighth asepct, since the tube guide and ball circulation tube are previously formed as an integral body, when assembling the ball circulation tube, not only there can be eliminated the time and labor to insert the ball circulation tube into the tube guide but also the ball circulation tube can be mounted with high position accuracy. Therefore, it is possible to manufacture a ball screw which not only can provide the effects obtained in the manufacturing method as set forth in Seventh aspect but also can further enhance the productivity and assembling efficiency thereof.

### BRIEF DESCRIPTION OF THE DRAWINGS

FIG. 1 is a partially broken-away front view of the main portions of a ball screw according to a first embodiment of the invention;

FIG. 2 is a plan view of the main portions shown in FIG. 1;

FIG. 3 is a schematically exploded front view of the main portions shown in FIG. 1;

FIG. 4 is an explanatory view of a tube guide according to the first embodiment of the invention;

FIG. 5 is an explanatory view of the process for manufacturing the tube guide;

FIG. 6 is a partially broken-away front view of the main portions of a ball screw according to a second embodiment of the invention;

FIG. 7 is an explanatory view of a ball screw according to a technology disclosed in the JP-UM-A-63-132156;

FIG. 8 is an explanatory view of a ball screw according to a technology disclosed in the JP-UM-A-63-132156;

FIG. 9 is an explanatory view of the problems found in a technology disclosed in the JP-UM-A-59-39352;

FIG. 10 is an explanatory perspective view of the main portions of a ball screw according to the technology disclosed in the JP-UM-A-59-39352; and,

FIG. 11 is a partially broken-away explanatory front view of a ball screw according to the technology disclosed in the JP-UM-A-59-39352.

### DETAILED DESCRIPTION OF THE PREFERRED EMBODIMENTS

Now, description will be given below of the mode for carrying out the invention with reference to the accompanying drawings. By the way, the same parts or equivalent parts to those used in the previously described related art are given the same designations.

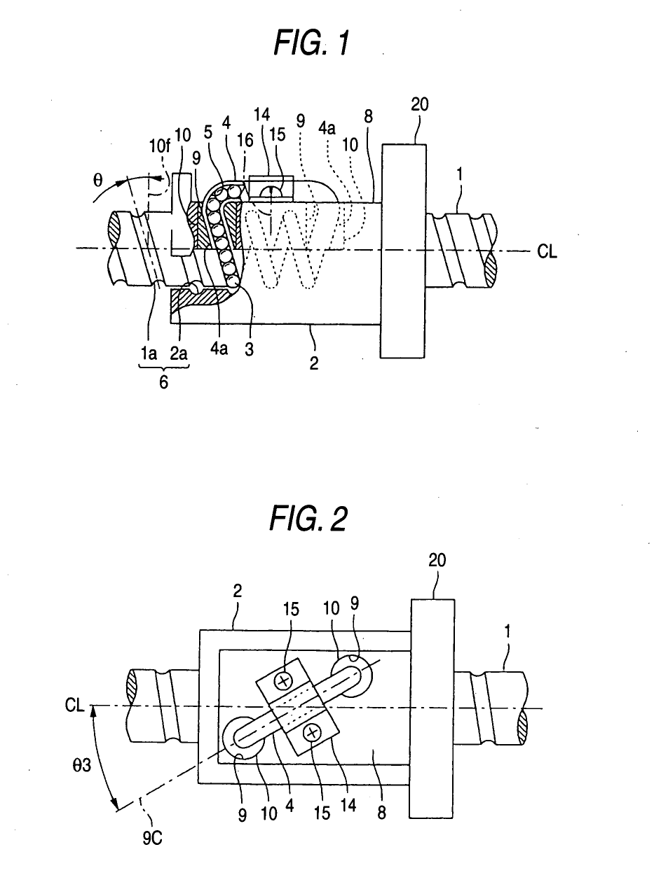

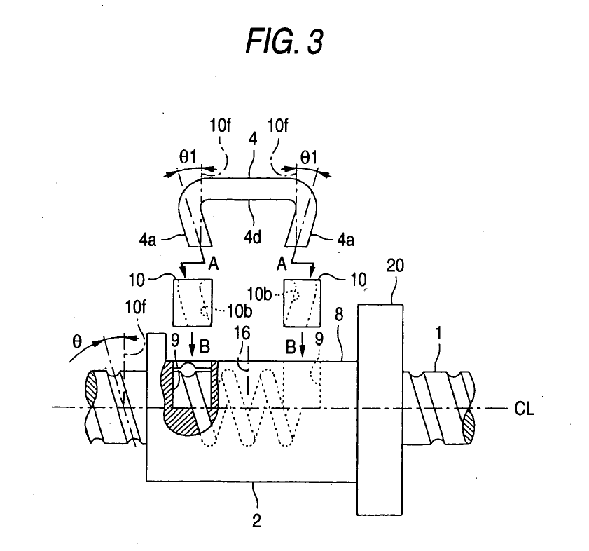

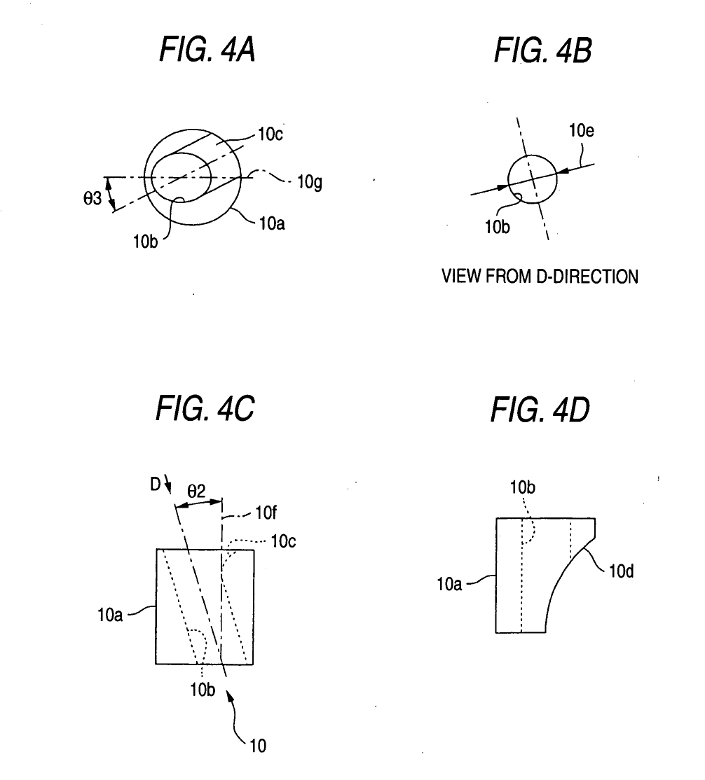

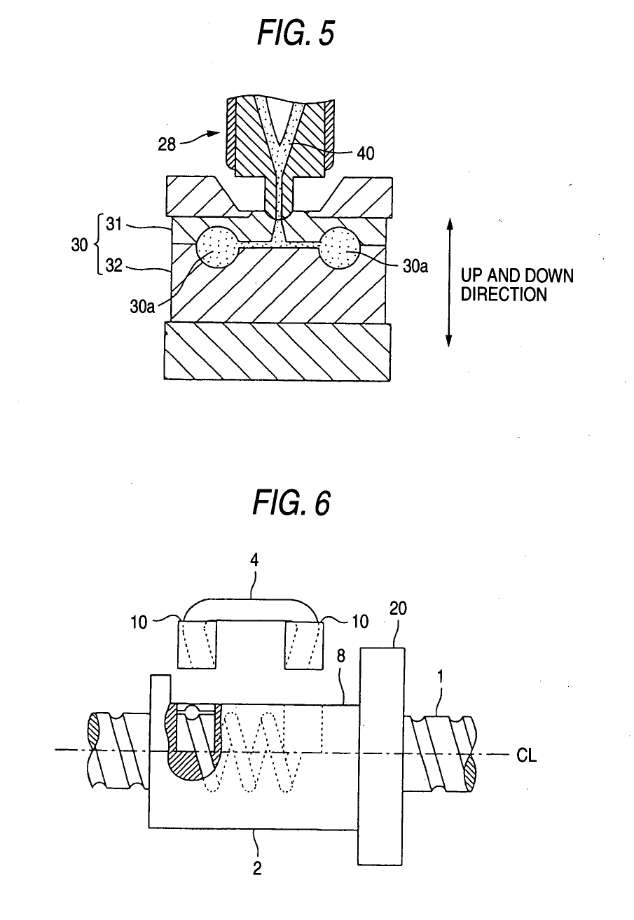

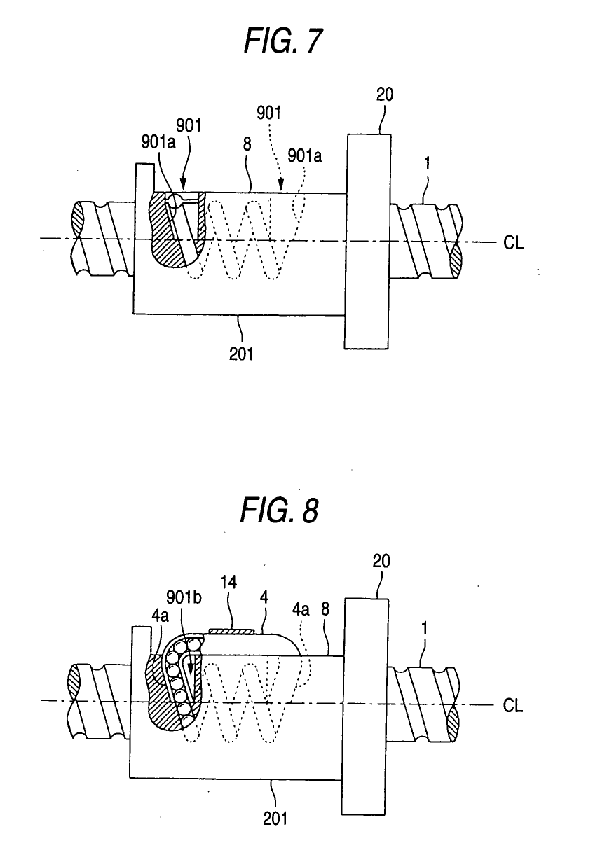

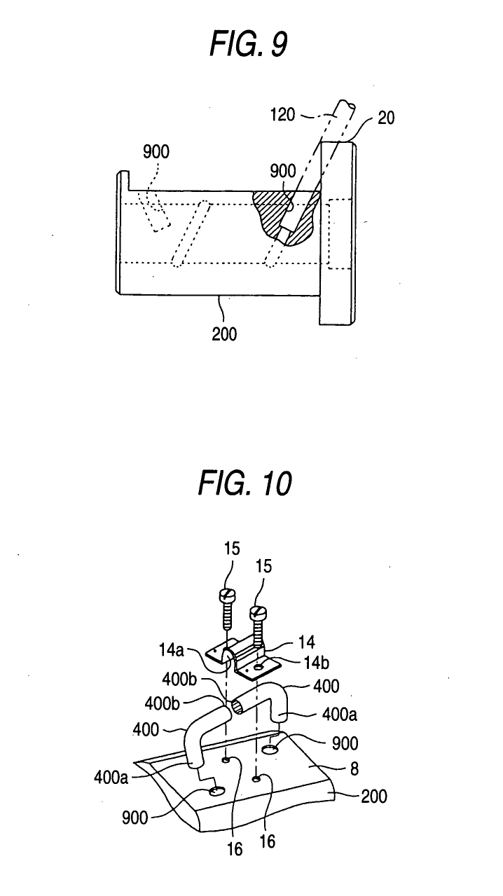

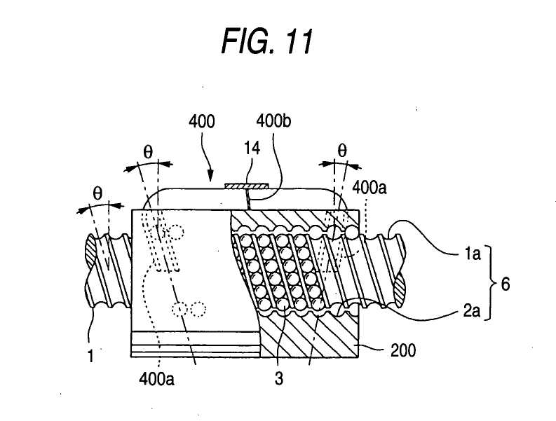

Here, FIG. 1 is a partially broken-away front view of the main portions of a ball screw according to a first embodiment of the invention, FIG. 2 is a plan view of the main portions shown in FIG. 1, FIG. 3 is an exploded front view of the main portions shown in FIG. 1, FIG. 4 is an explanatory view of a tube guide according to the first embodiment of the invention, and FIG. 5 is an explanatory view of the process for manufacturing the tube guide.

As shown in FIGS. 1 and 2, a screw shaft 1 includes a ball rolling groove 1a having an arc-shaped section formed in the outer surface thereof; and, a nut 2, which is to be fitted with the outer surface of the screw shaft 1, is a substantially cylindrical-shaped member including in the inner surface thereof a ball rolling groove 2a which corresponds to the ball rolling groove 1a of the screw shaft land, on the outer periphery of the nut 2 on one end side thereof, there is disposed amounting flange 20.

And, a plurality of balls 3 are disposed in a ball rolling passage 6 which is formed by these two ball rolling grooves 1a, 2a, while there is disposed a substantially U-shaped ball circulation tube 4 which includes in the two end portions thereof two ball scooping portions 4a for scooping up the balls 3 in such a manner that the balls 3 are allowed to circulate along the outer surface of the nut 2, and also the ball circulation tube 4 forms a ball circulation passage 5. The plurality of balls 3 and ball circulation tube 4 cooperate together in forming an endless circulation circuit. That is, due to the relative rotational movements of the nut 2 and screw shaft 1, the balls 3 are allowed to roll along the ball screw grooves 1a, 2a. And, in case where the balls 3 are scooped up by one of the ball scooping portions 4a of the ball circulation tube 4, while the advancing direction of the balls 3 is curved, the balls 3 move into the ball circulation tube 4, the balls 3 pass through the ball circulation tube 4 and step over the plurality of ball screw grooves 1a, 2a; and, after then, with the direction of the balls 3 being curved, the balls 3 move into between the ball screw grooves 1a, 2a from the opposite side end of the endless circulation circuit.

The outer peripheral surface of the nut 2 is machined by milling to thereby form an installation surface 8 for mounting the ball circulation tube 4 and tube holder 14 to the nut 2. And, the installation surface 8 is machined by tapping to thereby form a screw hole 16 for mounting the tube holder 14, while the screw hole 16 is situated at a position corresponding to the mounting position of the tube holder 14.

Further, at two positions in the installation surface 8, there are formed a pair of tube guide insertion holes 9 into which the ball scooping portions 4a of the two end portions of the ball circulation tube 4 are to be inserted through their associated tube guides 10. The tube guide insertion holes 9 are formed by machining the installation surface 8 of the nut 2 from a direction perpendicular to the installation surface 8 using an end mill (not shown) as a machining tool; and, the tube guide insertion holes 9 penetrate through the thickness portion of the nut 2 and communicate with the ball screw groove 2a formed in the inner surface of the nut 2.

The pair of tube guide insertion holes 9 are formed at positions where an angle formed by and between the line 9C connecting together the centers of the two insertion holes 9 and the axial line CL of the nut 2 can provide a given ball circulation tube inclination angle θ3. That is, since the advancing direction of the balls 3 is curved greatly when the balls 3 move into and out of the ball circulation tube 4, a large force is applied to the balls 3 in the interior of the ball circulation tube 4. In view of this, the ball circulation tube inclination angle θ3 is set so as to be able to eliminate the following problems: that is, the smooth movements of the balls 3 within the ball circulation tube 4 can be obstructed, the balls 3 can be clogged, and the ball circulation tube 4 can be damaged.

To produce the ball circulation tube 4, a metal-made pipe member having an inside diameter matched to the diameter of the balls 3 circulating in the interior of the ball circulation tube 4 may be bent formed into a U-shaped tube. Especially, the two ball scooping portions 4a of the two end portions of the ball circulation tube 4 are formed at an inclined ball circulation passage scooping angle θ1 coincident with the lead angle θ of the ball screw with respect to a direction 10f perpendicular to the axial line CL direction of the nut 2 (see FIG. 3).

Now, FIG. 4 shows a tube guide 10. To manufacture this tube guide 10, as the material of the tube guide 10, there may be used synthetic resin material having proper elasticity; that is, the synthetic resin material may be injection molded. As the synthetic resin material, there are used industrial plastics, so called engineering plastics which are excellent in mechanical strength, wear resistance and heat resistance and also which are often used as the material for mechanical parts. Preferably, for example, there may be used polyamide and polycarbonate.

The tube guide 10 has a substantially cylindrical outer shape 10a and includes two scooping portion insertion holes 10b into which the ball scooping portions 4a of the two end portions of the ball circulation tube 4 can be directly inserted.

The outer shape 10a has a substantially cylindrical shape which is matched to the inside diameter of the tube guide insertion hole 9 and can be thereby inserted into the tube guide insertion hole 9; and, the diameter of the outer shape 10a is set so as to be able to provide a close fit relation when the outer shape 10a is fitted into the tube insertion hole 9.

And, the scooping portion insertion hole 10b, as shown in its front view (FIG. 4B), has an inside diameter 10e (FIG. 4D) which is matched to the outside diameter of the ball circulation tube 4 to be inserted into the scooping portion insertion hole 10b; and, while a direction 10f perpendicular to the axial line CL direction of the nut 2 is considered as the vertical direction, the scooping portion insertion hole 10b penetrates through the tube guide 10 in the vertical direction at an insertion hole inclination angle θ2 coincident with the lead angle θ of the ball screw.

And, on the upper end side of the scooping portion insertion hole 10b, there is formed an end face 10c.

The end face 10c is chamfered in a smooth arc manner so that, when the ball scooping portion 4a is inserted into the tube guide 10, the end face 10c can follow the pipe inwardly bent shapes of the two sides of the ball circulation tube 4; and also, the end face 10c is formed at a ball circulation tube inclination angle θ3 which corresponds to the mounting state of the ball circulation tube 4 (see FIG. 4A which is a plan view of the tube guide 10, and FIG. 4B).

Also, in the tube guide 10, there is formed an arc-shaped relief portion 10d which extends from the side surface direction of the tube guide 10 (see the right side view of the tube guide 10 which is shown in FIG. 4D).

This relief portion 10d is formed so as to correspond to the inside diameter of the nut 2 in such a manner that, when the tube guide 10 is mounted onto the nut 2, the tube guide 10 can be prevented from interfering with the screw shaft 1 and balls 3.

Next, description will be given below of the process for manufacturing the tube guide 10 with reference to FIG. 5. However, since the injection molding of the tube guide 10 is carried out according to a conventionally normal method, in the following description, only the outline of the manufacturing process will be discussed in a simple manner.

A metal mold 30, which is used as a tube guide 10 molding frame, is made of steel material. The molding shape portions 30a (cavities) of the metal mold 30 each has a shape formed so as to correspond to the shape of the tube guide 10 which provides a molding, that is, the molding shape portion 30a has a female shape and the tube guide 10 has a male shape with respect to each other. And, the dimension of the molding shape portion 30a is set with the deforming amount thereof taken into account. Also, the metal mold 30 is composed of an upper mold 31 and a lower mold 32 and FIG. 5 shows an image in which two tube guides can be molded.

By the way, an injection molding machine 28 is a vertical-type injection molding machine of an in-line screw type and can be driven electrically.

In the molding process, molten synthetic resin material 40 (molten resin material) is poured into the metal mold 30.

And, after the synthetic resin material 40 is hardened, the metal mold 30 is opened vertically into the upper and lower molds 31 and 32, and the tube guides 10, which are the moldings, are taken out from the metal mold 30, thereby being able to provide the moldings.

As the tube holder 14, there is used a similar tube holder 14 to the related art. That is, as shown in FIG. 10, the tube holder 14 is molded of a springy thin plate; in the middle portion of the tube holder 14, there is bent formed a fitting groove 14a into which the ball circulation tube 4 can be fitted; and, in the longitudinal-direction two end portions of the tube holder 14, there are formed by pressing a plurality of (in FIG. 10, two) screw insertion holes 14b in such a manner to sandwich the fitting groove 14a, while the tube holder 14 can be fixed to the nut 2 through the screw insertion holes 14b.

Next, description will be given below of a method for mounting the ball circulation tube 4 onto the nut 2 with reference to FIG. 3.

To mount the ball circulation tube 4, there are used two tube guides 10 for each ball circulation tube 4. Firstly, the two ball scooping portions 4a of the two end portions of the ball circulation tube 4 are respectively inserted into the scooping portion insertion holes 10b of the two tube guides 10 with such care to the vertical direction thereof that the end faces 10c of the two tube guides 10 can follow the pipe inwardly bent shape of the ball circulation tube 4 (in FIG. 3, the arrow mark A).

Next, the two end portions of the ball circulation tube 4 are respectively inserted together with the tube guides 10 into the tube guide insertion holes 9 of the nut 2 to thereby assemble the ball circulation tubes 4 to the nut 2 (in FIG. 3, the arrow mark B). At the then time, the lower surface 4d of the ball circulation tube 4 is contacted with the installation surface 8.

Finally, the mounting screw 15 is fastened to the screw hole 16 through the tube holder 14 (FIG. 1). In this manner, the ball circulation tube 4 can be pressed against the installation surface 8 and can be thereby fixed to the installation surface 8 firmly. By the way, the large number of balls 3 to circulate through the interiors of the nut 2 and ball circulation tube 4 are previously charged into and disposed in these interiors and the balls 3, so that the balls 3 can be assembled into the ball screw simultaneously with the assembly of the ball circulation tube 4 to the nut 2.

As described above, according to the present embodiment, when the ball circulation tube 4 is mounted onto the nut 2, the two end portions of the ball circulation tube 4 are fitted through the tube guides 10 into the tube guide insertion holes 9 formed in the nut 2.

Thanks to this, the ball scooping portions 4a and tube guide insertion holes 9 can be made independent of each other and thus they can be designed in a desirable manner. That is, such a device for the ball scooping portion 4a as necessary to form the ball circulation passage 6 in a desirable manner can be set in a wide range with no restraint with respect to the machining operation of the nut 2. Also, since the nut 2 can be similarly machined free from the relationship between the nut 2 and ball scooping portion 4a, the range of the machining methods of the nut 2 and the freedom of design of the shape of the nut 2 are increased, which makes it possible to form the tube guide insertion hole 9 in the nut 2 according to a method which is most inexpensive and high in productivity.

And, the tube guide 10, which is interposed between the ball scooping portion 4a and tube guide insertion hole 9, is mounted so as to be matched to them, the tube guide 10 can be assembled without causing any clearance. This makes it possible to provide a tube guide 10 for a ball screw as well as a ball screw both of which can enhance the assembling efficiency of the ball circulation tube 4, can prevent the ball scooping portion 4a against damage, can prevent a foreign substance from entering the interior of the nut 2 from outside, and can reduce vibrations and noises.

Also, by improving the shape, material and manufacturing method of the tube guide 10 interposed between the ball scooping portion 4a and tube guide insertion hole 9 variously, the function and performance of the tube guide 10 for a ball screw and a ball screw can be enhanced further.

That is, the tube guide insertion hole 9 to be formed in the nut 2 can be machined by a machining tool in such a manner that the machining tool is handled from a direction perpendicular to the installation surface 8 of the nut 2 and, at the same time, the tube guide insertion hole 9 may be formed so as to have a simple cylindrical shape. This can enhance the machining efficiency and thus the productivity of the tube guide insertion hole 9, which in turn can reduce the machining time and cost of the tube guide insertion hole 9. By the way, in the present embodiment, the tube guide insertion hole 9 is formed by cutting. However, the tube guide insertion hole 9 can also be formed, for example, by electric discharge machining. In this case, the tube guide insertion hole 9 may be machined in such a manner that a mold corresponding to the interior shape of the tube guide insertion hole 9 is inserted in a direction perpendicular to the installation surface 8.

And, since the ball scooping portion 4a is formed at the ball circulation passage scooping angle θ1 inclined in correspondence to the lead angle θ of the ball screw, the ball scooping portion 4a can be prevented against damage as well as vibrations and noises can be reduced.

Also, because the tube guide 10 is made of synthetic resin material having elasticity by injection molding, the machining and assembling efficiency of the tube guide 10 can be enhanced further, the tube guide 10 can be mass produced, and vibrations and noises can be reduced. And, the tube guide 10 can be kept from rust and is excellent in friction resistance and wear resistance, so that the tube guide 10 is able to maintain its initial quality stably.

Further, a dimensional error with respect to the fitting condition between the tube guide 10 and tube guide insertion hole 9 can be absorbed by the elastic action of the tube guide 10; and, therefore, the tolerance limits can be set wide, thereby being able to improve the manufacturing yield rate of the tube guide 10.

Now, FIG. 6 shows a ball screw according to a second embodiment of the invention. The present embodiment is different from the previously described first embodiment in that the tube guides 10 to be fitted into the two end portions of the ball circulation tube 4 are manufactured by so called insert molding.

That is, as shown in FIG. 5, according to the second embodiment as well, in the above-mentioned injection molding, as a jig for positioning the ball circulation tube 4 serving as an insert part, there is used a metal mold 30. As described above, since the injection molding machine is a vertical-type injection molding machine, the opening and closing operation of the metal mold 30 is executed in the vertical direction. That is, because the surface of a lower mold 32 faces upwardly, the positioning of the part to be inserted can be facilitated.

Specifically, in a state where the metal mold 30 is opened in the vertical direction, the ball scooping portions 4a of the two end portions of the ball circulation tube 4 are mounted at given positions on the lower mold 32 according to the positioning shape of the insert part formed on the surface of the lower mold 32; and, after then, by closing the upper and lower molds together, the ball scooping portions 4a can be firmly held in a state where they are inserted into the molding shape portions 30a of the metal mold. And, molten synthetic resin material 40 is poured into the peripheries of the ball scooping portions 4a and the ball scooping portions 4a are thereby enclosed by the synthetic resin material 40; and, after then, the synthetic resin material 40 is hardened, thereby manufacturing a ball screw as a composite part in which the ball circulation tube 4 and tube guides 10 are formed as an integral body.

By the way, in order to carry out the insert molding operation automatically, in case where an automatic apparatus is structured by using a robot, an air-drive-type take-out device, a resin supply device, a gate cut device and a molding ejector device properly, the productivity and quality of the ball screw can be enhanced further. Also, when carrying out the insert molding operation by human hands, for example, in case where the metal mold is turned in combination with a rotary table, the surface of the metal mold can be made easy to look at, thereby being able to carry out the insert operation more safely and efficiently.

As described above, according to the second embodiment, since the tube guides 10 are manufactured by insert molding, the assembling step, which is the next step, can be made more efficient.

That is, the ball circulation tube 4 and tube guides 10 are previously formed as an integral body. Thanks to this, in assembling them together, not only there can be eliminated time and labor for insertion of the ball circulation tube 4 into the tube guides 10 (in FIG. 3, the step shown by the arrow mark A) but also they are mounted with high position accuracy, which can provide an advantage that the assembling efficiency of the ball screw can be enhanced still further.

And, since the ball circulation tube 4 and tube guides 10 are previously formed as an integral body, it is also possible to bend the ball scooping portions 4a in shape. That is, the curvature of the U-shaped bent machined portions of the two sides of the ball circulation tube 4 can be extended up to the ball scooping portions 4a sides and can be thereby made gentler. This can provide an advantage that the operation of the balls 3 rolling in the interior of the ball circulation passage 5 can be made further smoother.

Also, because the tube guides 10 are formed on the two end portions of the ball circulation tube 4 integrally therewith, there is provided another advantage that the fixation holding capability of the ball circulation tube 4 can be enhanced further.

The remaining operations and effects of the second embodiment are similar to those of the first embodiment.

By the way, in the above-described embodiments, as the material for the tube guide 10, there is used synthetic resin material having elasticity. However, the elastic material may include rubber or the like; that is, the tube guide 10 may be made of rubber or the like. Also, the tube guide 10 may also be made of metal material by machining, or may be manufactured by MIM (Metal Injection Molding) or by metallurgy such as sintering. Further, in the illustrated embodiments, the tube guide 10 is composed of a single body. However, the tube guide 10 may also be divided into a plurality of parts; that is, after these parts are produced separately, they may be combined together to thereby produce a complete tube guide member 10.

And, the ball circulation tube 4 is formed by bending a pipe member; however, the ball circulation tube 4 may also have a structure which can be obtained by combining together two or more press plates each having a semicircular section.

Also, in the illustrated embodiments, description has been given of the case in which the endless circulation circuit is a single circuit using a single ball circulation tube 4. However, the invention is not limited to this but the invention can also be applied to a ball screw which includes a plurality of (for example, two) endless circulation circuits each including a ball circulation tube 4 having the above-mentioned-type mounting structure.

As has been described heretofore, according to the invention, it is possible to provide a tube guide for a ball screw, a ball screw and a method for manufacturing a ball screw which not only can enhance the efficiency of such machining operation of a nut as necessary to mount a ball circulation tube onto the nut and the efficiency of the assembling of the ball circulation tube to the nut, but also can prevent a foreign substance from entering the interior of the nut from outside.

1. A tube guide for a ball screw comprising a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut,
wherein the tube guide is used for mounting the ball circulation tube onto the nut, has an outer shape matched to the inner shape of a tube guide insertion hole formed in the nut so as to correspond to the insertion position of the ball scooping portion, and includes a scooping portion insertion hole consisting of a penetration hole formed so as to have an inner shape matched to the outer shape of the ball scooping portion, and
wherein the tube guide is interposed between the ball scooping portion and the tube guide insertion hole.

2. A tube guide for a ball screw as set forth in claim 1, wherein the inner shape of the tube guide insertion hole is formed a cylindrical shape.

3. A tube guide for a ball screw as set forth in claim 2, wherein the axial line of the cylindrical shape is set perpendicular to the axial line of the nut.

4. A tube guide for a ball screw as set forth in claim 1, wherein the scooping portion insertion hole has a ball circulation passage scooping angle set so as to correspond to the lead angle of the ball screw.

5. A tube guide for a ball screw as set forth in claim 2, wherein the scooping portion insertion hole has a ball circulation passage scooping angle set so as to correspond to the lead angle of the ball screw.

6. A tube guide for a ball screw as set forth in claim 3, wherein the scooping portion insertion hole has a ball circulation passage scooping angle set so as to correspond to the lead angle of the ball screw.

7. A tube guide for a ball screw as set forth in claim 1, wherein the tube guide is made of elastic material.

8. A tube guide for a ball screw as set forth in claim 2, wherein the tube guide is made of elastic material.

9. A tube guide for a ball screw as set forth in claim 3, wherein the tube guide is made of elastic material.

10. A tube guide for a ball screw as set forth in claim 6, wherein the tube guide is made of elastic material.

11. A ball screw comprising:
a screw shaft including a spiral-shaped ball rolling groove formed in an outer peripheral surface thereof;
a nut including a spiral-shaped ball rolling groove formed in an inner peripheral surface thereof;
a plurality of balls disposed in a ball rolling passage formed by the two ball rolling grooves; and,
a ball circulation tube forming a ball circulation passage and including a ball scooping portion in an end portion thereof, the balls being scooped up at the ball scooping portion so as to circulate along the outer surface of the nut,
wherein the nut includes a tube guide insertion hole corresponded to the insertion position of the ball scooping portion, and the ball circulation tube is mounted on the nut through a tube guide as set forth in claim 1 between the ball scooping portion and the tube guide insertion hole.

12. A ball screw comprising:
a screw shaft including a spiral-shaped ball rolling groove formed in an outer peripheral surface thereof;
a nut including a spiral-shaped ball rolling groove formed in an inner peripheral surface thereof;
a plurality of balls disposed in a ball rolling passage formed by the two ball rolling grooves; and,
a ball circulation tube forming a ball circulation passage and including a ball scooping portion in an end portion thereof, the balls being scooped up at the ball scooping portion so as to circulate along the outer surface of the nut,
wherein the nut includes a tube guide insertion hole corresponded to the insertion position of the ball scooping portion, and the ball circulation tube is mounted on the nut through a tube guide as set forth in claim 2 between the ball scooping portion and the tube guide insertion hole.

13. A ball screw comprising:
a screw shaft including a spiral-shaped ball rolling groove formed in an outer peripheral surface thereof;
a nut including a spiral-shaped ball rolling groove formed in an inner peripheral surface thereof;
a plurality of balls disposed in a ball rolling passage formed by the two ball rolling grooves; and,
a ball circulation tube forming a ball circulation passage and including a ball scooping portion in an end portion thereof, the balls being scooped up at the ball scooping portion so as to circulate along the outer surface of the nut,
wherein the nut includes a tube guide insertion hole corresponded to the insertion position of the ball scooping portion, and the ball circulation tube is mounted on the nut through a tube guide as set forth in claim 3 between the ball scooping portion and the tube guide insertion hole.

14. A ball screw comprising:
a screw shaft including a spiral-shaped ball rolling groove formed in an outer peripheral surface thereof;
a nut including a spiral-shaped ball rolling groove formed in an inner peripheral surface thereof;
a plurality of balls disposed in a ball rolling passage formed by the two ball rolling grooves; and,
a ball circulation tube forming a ball circulation passage and including a ball scooping portion in an end portion thereof, the balls being scooped up at the ball scooping portion so as to circulate along the outer surface of the nut,
wherein the nut includes a tube guide insertion hole corresponded to the insertion position of the ball scooping portion, and the ball circulation tube is mounted on the nut through a tube guide as set forth in claim 6 between the ball scooping portion and the tube guide insertion hole.

15. A ball screw comprising:
a screw shaft including a spiral-shaped ball rolling groove formed in an outer peripheral surface thereof;
a nut including a spiral-shaped ball rolling groove formed in an inner peripheral surface thereof;
a plurality of balls disposed in a ball rolling passage formed by the two ball rolling grooves; and,
a ball circulation tube forming a ball circulation passage and including a ball scooping portion in an end portion thereof, the balls being scooped up at the ball scooping portion so as to circulate along the outer surface of the nut,
wherein the nut includes a tube guide insertion hole corresponded to the insertion position of the ball scooping portion, and the ball circulation tube is mounted on the nut through a tube guide as set forth in claim 10 between the ball scooping portion and the tube guide insertion hole.

16. A method for manufacturing a ball screw comprising: a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 1 on the two end portions of the ball circulation tube;
inserting the two end portions of the ball circulation tube with the tube guide into the tube guide insertion holes; and,
fixing the ball circulation tube to the nut.

17. A method for manufacturing a ball screw comprising:
a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 2 on the two end portions of the ball circulation tube;
inserting the two end portions of the ball circulation tube with the tube guide into the tube guide insertion holes; and,
fixing the ball circulation tube to the nut.

18. A method for manufacturing a ball screw comprising:
a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 3 on the two end portions of the ball circulation tube;
inserting the two end portions of the ball circulation tube with the tube guide into the tube guide insertion holes; and,
fixing the ball circulation tube to the nut.

19. A method for manufacturing a ball screw comprising: a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 6 on the two end portions of the ball circulation tube;
inserting the two end portions of the ball circulation tube with the tube guide into the tube guide insertion holes; and,
fixing the ball circulation tube to the nut.

20. A method for manufacturing a ball screw comprising:
a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 10 on the two end portions of the ball circulation tube;
inserting the two end portions of the ball circulation tube with the tube guide into the tube guide insertion holes; and,
fixing the ball circulation tube to the nut.

21. A method for manufacturing a ball screw comprising: a screw shaft including a spiral-shaped ball rolling groove formed in an outer peripheral surface thereof; a nut including a spiral-shaped ball rolling groove formed in an inner peripheral surface thereof; a plurality of balls disposed in a ball rolling passage formed by the two ball rolling grooves; and, a ball circulation tube forming a ball circulation passage and including a ball scooping portion in an end portion thereof, the balls being scooped up at the ball scooping portion so as to circulate along the outer surface of the nut, comprising steps of:
forming a tube guide insertion hole on the nut at a position corresponding to the insertion position of the ball scooping portion;
mounting the tube guide as set forth in claim 15 on the two end portions of the ball circulation tube;
inserting the two end portions of the ball circulation tube with the tube guide into the tube guide insertion holes; and,
fixing the ball circulation tube to the nut.

22. A method for manufacturing a ball screw as set forth in claim 16, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

23. A method for manufacturing a ball screw as set forth in claim 17, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

24. A method for manufacturing a ball screw as set forth in claim 18, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

25. A method for manufacturing a ball screw as set forth in claim 19 wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

26. A method for manufacturing a ball screw as set forth in claim 20, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.

27. A method for manufacturing a ball screw as set forth in claim 21, wherein, in a state where the two end portions of the ball circulation tube are inserted into a mold for molding a tube guide, material for the tube guide is poured into the tube guide molding mold and is hardened therein, whereby the step of manufacturing the tube guide and the step of mounting the tube guide onto the two end portions of the ball circulation tube is executed at the same time.
